(19) United States
(12) Patent Application Publication
(10) Pub. No.: US 2004/0130616 A1
(43) Pub. Date: Jul. 8, 2004

(54) Flip-open screen with audio/video player

(76) Inventor: Thomas Tseng, La Habra Heights, CA (US)

Correspondence Address: JOE NIEH, 18760 E. AMAR ROAD #204, WALNUT, CA, 91789, US

(21) Appl. No.: 10/336,433

(22) Filed: Jan. 3, 2003

(51) Int. Cl. H04N 7/18

(52) U.S. Cl. 348/61

(57) ABSTRACT

A video screen that can be flipped open with an audio/video source mounted behind it and attached to the back of the headrest on the seat of an automobile is disclosed. The audio/video source may be an AM/FM radio, an AM/FM radio with cassette player, an AM/FM radio with CD player, a DVD player, a video game console, or any other suitable audio/video source. The video screen is rotably attached to the audio/video source which is attached to the back of the headrest of the seat in front of the user. The video screen may be flipped open to reveal the audio/video source to allow the user to change media or control the functions of the audio/video source. The flip-open video screen with the audio/video source mounted behind it and attached to the back of the headrest of the seat of an automobile will allow the rear seat passengers to individually, fully, and easily control their desired source of entertainment during their occupancy of the automobile without disturbing the other passengers of the vehicle.

### BACKGROUND-FIELD OF INVENTION

The present invention relates generally to a video display with an audio/video source mounted behind it and attached to the back of the headrest on the seat of a vehicle. More specifically the present invention is a video screen that can be flipped open with an audio/video player unit mounted behind it and attached to the back of the headrest on the seat of a vehicle.

### BACKGROUND-DESCRIPTION OF RELATED ART

Modern vehicles are not simply a means of transportation. Automobiles not only transport people from one place to another but also provide entertainment to the occupants during transit. The entertainment source may be in the form of a simple AM/FM radio, an AM/FM radio with cassette player, an AM/FM radio with CD player, a CD player, a DVD player, a video game console, or any other audio/video source.

Generally the entertainment source is installed inside the dashboard within the center console and within easy reach of the driver and front passenger of an automobile. The bulkier units such as a CD changer and a video cassette player may be installed inside the trunk of an automobile with the controls installed on the center console of the dash board. The rear seat passengers generally cannot reach and control the entertainment source from the back seat of the automobile with the exception of some very high end luxury automobiles that have additional controls at the rear seats. Therefore, the rear seat passengers are generally passive listeners/viewers due to the lack of control of the entertainment source. Furthermore, all occupants of the automobile must listen to or view the same source of entertainment.

### SUMMARY OF THE INVENTION

The present invention is a video screen that can be flipped open with an audio/video source mounted behind it and attached to the back of the headrest on the seat of an automobile. The audio/video source may be an AM/FM radio, an AM/FM radio with cassette player, an AM/FM radio with CD player, a DVD player, a video game console, or any other suitable audio/video source. The video screen is rotably attached to the audio/video source which is attached to the back of the headrest of the seat in front of the user. The video screen may be flipped open to reveal the audio/video source to allow the user to change media or control the functions of the audio/video source. The flip-open video screen with the audio/video source mounted behind it and attached to the back of the headrest of the seat of an automobile will allow the rear seat passengers to individually, fully, and easily control their desired source of entertainment during their occupancy of the automobile without disturbing the other passengers of the vehicle.

### BRIEF DESCRIPTION OF THE DRAWINGS

FIG. 1 shows the flip-open screen with a DVD player mounted behind it.

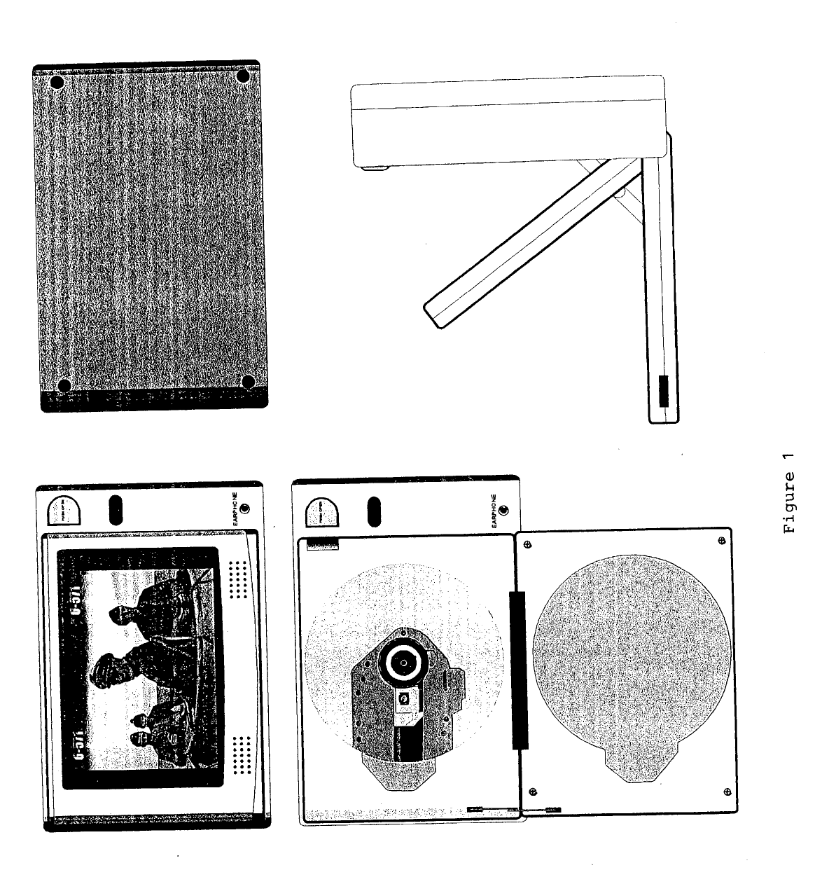

FIG. 2 shows the flip-open screen with a DVD player mounted behind it and attached to the back of the headrest on the seat of a vehicle during use.

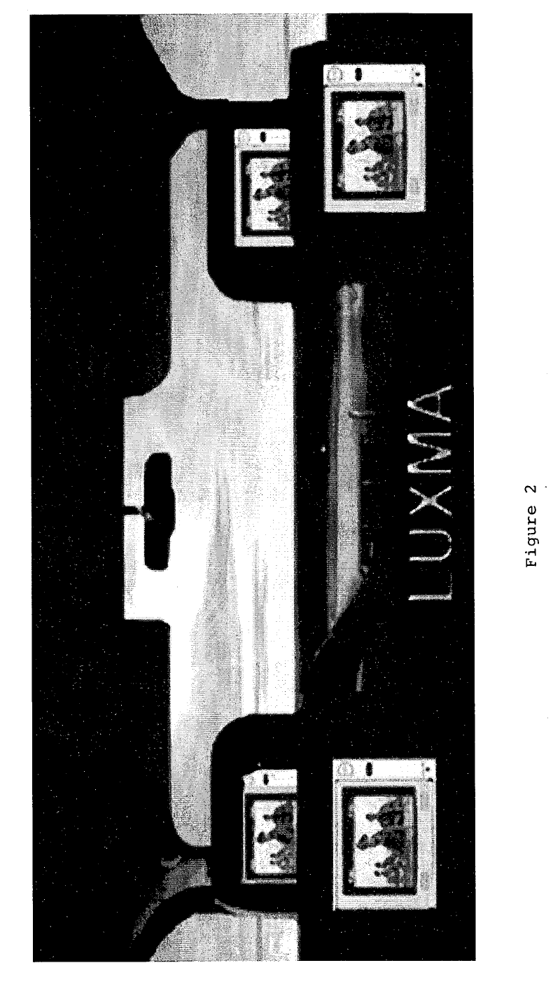

### DETAILED DESCRIPTION OF THE PREFERRED EMBODIMENT

A flip-down screen with an audio/video source mounted behind it and mounted to the back of the headrest of the seat in an automobile. The audio/video source may be an AM/FM radio, an AM/FM radio with cassette player, an AM/FM radio with CD player, a DVD player, a video game console, or any other suitable audio/video source. The flip-down screen with the audio/video source mounted behind it and mounted to the back of the headrest of the seat in an automobile will allow the rear seat passengers to independently, fully, and easily control their desired source of entertainment during their occupancy of the automobile without disturbing the other passengers of the automobile.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A flip-open screen with audio/video player comprising:
a video display; and
an audio/video source;
wherein the video display is rotably attached to the audio/video source which is attached to a headrest on a sear of a vehicle such that the video display may be flipped open to reveal the audio/video source for change of media or control of its functions.

2. A flip-open screen with audio/video player as in claim 1, wherein the audio/video source is an AM/FM radio.

3. A flip-open screen with audio/video player as in claim 1, wherein the audio/video source is an AM/FM radio with cassette player.

4. A flip-open screen with audio/video player as in claim 1, wherein the audio/video source is an AM/FM radio with CD player.

5. A flip-open screen with audio/video player as in claim 1, wherein the audio/video source is a CD player.

6. A flip-open screen with audio/video player as in claim 1, wherein the audio/video source is a DVD player.

7. A flip-open screen with audio/video player as in claim 1, wherein the audio/video source is a video cassette player.

8. A flip-open screen with audio/video player as in claim 1, wherein the audio/video source is a video game console.

9. A flip-open screen with audio/video player comprising:
a video display; and
an audio/video source;
wherein the video display is attached by a hinge to the audio/video source which is attached to a headrest on a sear of a vehicle such that the video display may be flipped downward to reveal the audio/video source for change of media or control of its functions.

10. A flip-open screen with audio/video player as in claim 9, wherein the audio/video source is an AM/FM radio.

11. A flip-open screen with audio/video player as in claim 9, wherein the audio/video source is an AM/FM radio with cassette player.

12. A flip-open screen with audio/video player as in claim 9, wherein the audio/video source is an AM/FM radio with CD player.

13. A flip-open screen with audio/video player as in claim 9, wherein the audio/video source is a CD player.

14. A flip-open screen with audio/video player as in claim 9, wherein the audio/video source is a DVD player.

15. A flip-open screen with audio/video player as in claim 9, wherein the audio/video source is a video cassette player.

16. A flip-open screen with audio/video player as in claim 9, wherein the audio/video source is a video game console.
